(19) United States
(12) Patent Application Publication
(10) Pub. No.: US 2015/0327955 A1
(43) Pub. Date: Nov. 19, 2015

(54) FACIAL SCULPTURING DENTAL APPLIANCE

(71) Applicant: REVITABITE, LLC, White Plains, NY (US)

(72) Inventors: David Hanswirth, White Plains, NY (US); Lucia D. Banko, Armonk, NY (US)

(73) Assignee: REVITABITE, LLC, White Plains, NY (US)

(21) Appl. No.: 14/277,490

(22) Filed: May 14, 2014

(51) Int. Cl. A61C 5/14

(52) U.S. Cl. CPC A61C 5/14

(57) ABSTRACT

A dental appliance to reduce the effect of facial age lines has a U-shaped planar part or piece with a curved central part and two generally straight leg parts extending therefrom. The planar piece has an upper surface that is continuous and generally unobstructed. A lower surface of the planar piece has an elongated flap that extends along the outer edge of each leg of the planar piece and engages the outer sides of the lower teeth of the user so as to align the appliance during fitting and use. The lower surface is continuous and generally unobstructed, except for the flap. Bite pads are located on the upper and lower surfaces of both legs in the unobstructed areas. A wing extends upwardly from the top surface of the planar piece at its outer edge where the legs extend into the curved central part on each side. These wings engage the inside of the lips in the areas of the nasolabial fold lines and are preloaded to push them outwardly during use.

### FIELD OF THE INVENTION

The present application relates generally to a dental appliance used to support the muscles of the face and neck in order to reduce the appearance of facial aging, and a method of fitting the appliance.

### BACKGROUND OF THE INVENTION

As people age the facial muscles become less taut and sag. This causes the skin of the face to sag and gives the appearance of facial aging. People with sagging facial muscles often maintain their jaws in an over-closed condition instead of in a normal rest posture. The normal rest posture is the jaw position in which the jaws are relaxed and the teeth are spaced apart so that the occlusal surfaces of the upper and lower teeth are not engaged. When the jaw is kept more tightly closed than in the normal rest posture there is little vertical separation between the upper and lower teeth. In this over-closed condition the bones do not get stimulated because there are facial muscles that are not at their peak level of activity.

Various dental appliances that do not require surgical implantation exist in the market that aim to reduce the appearance of aging in the face, mouth and neck areas. One such appliance, or prosthesis, believed to be known as the “Angelift,” is described in U.S. published Applications No. 2005/0175963 of Bruce, published Aug. 11, 2005 and No. 2006/0172262 of Bruce, published Aug. 3, 2006. This appliance is formed to fit around the upper or lower gum. The appliance has an upper and lower support in the anterior vestibule between the alveolar mucosa and the lip. The supports are intended to contact and push the facial skin around the mouth and jaw outwardly to reduce the appearance of wrinkles or aging lines. The thickness of the appliance can be varied to achieve a desired facial appearance. The appliance is attached to the teeth by wires.

Another such appliance is known as the “Oralift,” which appears to be the subject of U.S. Pat. No. 7,416,516 of Mohindra. This is an appliance for reducing facial aging which is formed of an elastomeric material that can be fitted to the teeth so as to maintain a predetermined vertical separation of the jaws to reestablish the jaw rest posture at various vertical heights. When the jaws are in the resting posture there is a freeway space between the teeth. This freeway space is defined as the inter-occlusal distance or separation between the occlusal surfaces of the teeth when the mandible is in its physiologic rest position. When the jaws are relaxed in a normal rest posture, the freeway space is usually from about 2.5-3 mm. When the jaws are more tightly clenched, the freeway space is less. The Mohindra Oralift causes the resting posture of the jaws to be at least 3 mm greater than normal. Thus, if the freeway space with the jaws relaxed in their rest position is from about 2.5-3.0 mm, the appliance of the Mohindra patent would keep the teeth further separated and make the freeway space about 6 mm. In actual use of the Oralift appliance, and as disclosed in the patent, the additional separation from the normal jaw relaxed rest position is reported to be as much as 20 mm, which would make the freeway space even greater.

The appliance of the Mohindra patent does not have any way to push out selected areas of the face, particularly at the nasolabial folds of the face. Also, the Oralift appliance is one that is often fitted by a dentist with special training and a technician is required to fabricate it.

In U.S. Pat. No. 4,580,980 of Acquanetta a denture is disclosed for reducing the cosmetic effect of facial age lines. The denture, shown for the upper set of teeth, includes protuberances extending from what corresponds to the denture gum area to engage the inside of the cheek to stretch the overlying skin so as to urge age lines into a more youthful configuration. This appliance is useful only for people without normal teeth and requires special fitting.

The present inventors are the inventors of the subject matter in U.S. Pat. No. 8,419,595, which is directed to an elastomeric dental appliance which reduces the effect of facial age lines. This appliance has a U-shaped channel piece with a continuous bottom wall, vertical walls extending from the bottom wall inner and outer edges, bite pads on the upper and lower surfaces of both legs of the U-shaped channel piece, and a wing extending upwardly from the top edge of the outer vertical wall of each channel piece leg to engage the inside of the lips in the areas of the nasolabial fold lines and to push them outwardly. The appliance is fitted using the boil and bite method, during which the user protrudes his or her lower jaw by a distance of from 1-3 mm. As a result, when the appliance is used it provides a vertical separation of about 3 mm between the opposing teeth occlusal surfaces with the jaw protruding forward. This has the effect of supporting the muscles of the face and neck to reduce the appearance of facial aging.

However, it has been discovered by the present inventors that the device of their prior patent could be improved. In particular, the upper vertical walls and the channel for the teeth limit the variety of people who can use any one set of dimensions for the appliance. Thus, a number of different models have to be provided to cover most people. Also, with the prior device the wings had to be manipulated by the user to achieve their intended purpose.

Accordingly, it is desired to provide a dental appliance that does not have to be surgically implanted, that can achieve the desired effect of reducing the appearance of aging in the face, that can be easily fitted to a user, even by the user himself, that fits a wide variety of people, and that has wings that automatically assume an effective position when put into use.

### SUMMARY OF THE INVENTION

The present invention is designed to be an over-the-counter oral appliance, which when worn regularly reduces the signs of facial aging. The appliance is fitted between the teeth and worn for about 5 minutes per day. In accordance with the invention, an elastomeric dental appliance is provided that produces the desired result of achieving the appearance of a reduction in facial aging, that can be easily fitted to a user and that fits a wide variety of users. The appliance also reduces the appearance of aging in the mouth and neck areas. The appliance of the invention reestablishes the jaw rest posture vertical separation such that facial muscles are made tauter. The appliance is constructed so that it also engages other parts of the face to improve appearance and to strengthen other parts of the facial structure. Further, it is fitted so that when it is used, it protrudes the jaw forward to stretch the neck muscles.

The appliance is formed as a U-shaped piece of an elastomeric material. However, instead of a channel shape having a continuous bottom wall which limits the various arrangements of teeth that will fit the appliance, it has an open planar shape that does not confine the teeth. Thus, it does not have significant walls that extend substantially vertically upward (toward the upper teeth) from each edge the upper side of a bottom wall. Nevertheless, it does have bite pads that are provided on both the upper and lower surfaces of both legs of the U- shaped planar piece in which teeth depressions are made during fitting of the appliance by a user. Circular shaped wings extend from the front edge of the circular part of the U-shaped planar piece to the location where the circular part meets both legs of the U-shape to engage the inside of the upper lip and support the nasolabial fold of the face. However, the wings are made of a resilient material or have a resilient material in them, in order to preload the wings so they automatically flex outward into contact with the tissue of the nasolabial fold. This provides lip support and increases Cupid's Bow. A low vertical wall may be provided at the curved central part of the U-shaped planar piece to engage the lower lip around the mouth opening. This stretches the obicularis oris muscle so as to re-establish the sarcomere length. Further, a low vertical wall or flap extends downwardly from the posterior section of each U-shaped leg to engage the outer surface of the lower teeth and gums in order to align the appliance.

The appliance preferably is made of an elastomeric material that is fitted to a user with the boil and bite method in which the appliance is placed in hot water to soften so that its parts can be deformed when fitted in the mouth of a user. The appliance is then inserted into the user's mouth so that the U-shaped planar piece, lower vertical wall and wings are conformed to the jaw, teeth and facial structure of the user. The user closes his jaws so the teeth bite into the bite pads and make impressions into which the teeth are to fit when the appliance has cooled and is later being used. Because the bite pads are on a planar surface as opposed to in a channel, the appliance can accommodate a wide variety of mouth sizes and tooth configurations. During this boil and bite fitting of the appliance, when the teeth impressions are made in the bite pads, the jaw preferably is protruded forward from its normal position by a desired amount, typically 1-3 mm.

The wings are preloaded. As a result, they naturally flex outward into contact with the inside of the upper lip and support the nasolabial fold of the face. The prior devices with wings had to be manually placed in the correct position, which could be different for each user. Thus, some users who did not properly place the wings could lose some of the benefit of the appliance. However, with the present invention the wings will automatically flex outward into contact with the upper lip structure of most users.

The appliance is constructed so that when it is used with the teeth in the bite pad impressions, a rest posture is established that has a freeway space between the teeth of about 7 mm. The re-established vertical distance of the rest posture will stretch the facial muscles and stimulate the obicularis oris. Also, when the appliance is in use, the protrusion of the jaw from its normal position set during fitting of the appliance gives support to the neck muscles and the area under the chin. The jaw protrusion also increases support of the muscles around the cheekbones.

A user wearing the appliance will have the combined beneficial effects of the re-established vertical separation, jaw protrusion, engagement of the inner lips at the nasolabial fold lines by the appliance wings, and engagement of the lower face by outer flaps that overlie the outside of the lower teeth and gums. Further, there may be a low vertical wall at the curved central part of the U-shaped planar piece that contacts the lower part of the upper lip. All of these will contribute to reducing the appearance of the aging effect.

As another advantage, the user of the appliance does not necessarily have to visit a dental office in order to have the appliance fitted and to learn how to use it. From a cost perspective, since one configuration of the appliance will fit a larger number of people, manufacturing is easier and less expensive, which savings can be passed onto the consumer in terms of a lower price for the appliance.

### BRIEF DESCRIPTION OF THE DRAWINGS

The foregoing and other features of the present invention will be more readily apparent from the following detailed description and drawings of an illustrative embodiment of the invention in which:

FIG. 1 is a top, left side perspective view of a dental appliance according to the present invention;

FIG. 2 is a front elevational view of the appliance of FIG. 1;

FIG. 3A is a rear elevational view of the appliance of FIG. 1 and FIG. 3B is a cross-section of the appliance as shown in FIG. 1 along lines 3B-3B;

FIG. 4 is a bottom plan view of the appliance of FIG. 1;

FIG. 5 is a top plan view of the appliance of FIG. 1;

FIG. 6 is a cross section of the appliance as shown in FIG. 3A along lines 6-6; and

FIG. 7 is a drawing of the human face which shows the appliance in place and engaging the mouth and face.

### DESCRIPTION OF AN ILLUSTRATIVE EXEMPLARY EMBODIMENT

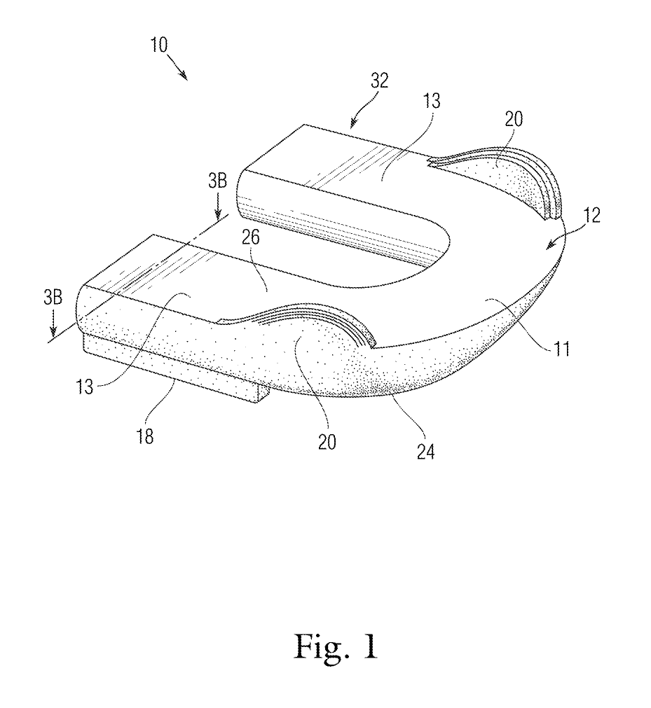

FIGS. 1-6 show the appliance 10 which is to fit on the lower set of teeth of a user. The appliance has a generally U or horseshoe-shaped planar part 12. In particular it has a curved central part 11 from which extend two relatively straight leg parts 13. The U-shaped planar part 12, unlike the prior art, has no inner or outer walls extending vertically upward from the edges of the top surface of the leg parts, which would form a channel restricting the arrangement of teeth which it could accommodate. As a result, it can accommodate users with a wide variety of jaw sizes and arrangements of teeth.

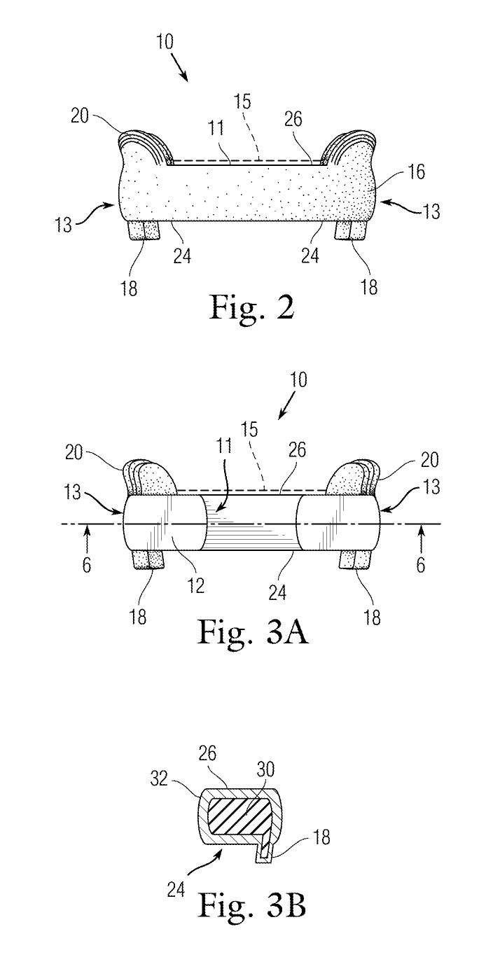

The curved part 11 may include a low vertical wall 15 shown in dotted line in FIGS. 2 and 3A. When installed in the user's mouth this wall comes in contact with the lower part of the inside of the user's upper lip, which contact can help to reduce aging lines in that area. To assist in this contact, the vertical wall 15 can have a textured surface to increase the friction contact between the wall and the inside of the lip.

As used in this application, the directions, e.g., upward, downward, outward, etc., refer to the position of the appliance when installed in the mouth of a user and that user is sitting or standing up with his or her head erect. When not in place in the user's mouth, such directions have no meaning and are to be taken as relative directions and positions with respect to the ones when installed in the user's mouth.

An elongated flap 18 extends downwardly from the lower surface of the planar part 12 at the outer edge of the straight parts of each leg 13. Each flap 18 extends for a distance slightly beyond the straight part of each leg 13 to a point at the start of the curved central part 11 of the planar part 12. When the appliance is fitted, each flap 18 will extend over the outer surface of the lower teeth and somewhat over the gums. The flaps will also engage the inside of the lower part, approximately the lower third, of the face and give support to the skin in this area of the face. In a typical embodiment the flaps 18 are about 2 mm in height and thickness.

Extending upwardly from the top surface of planar part 12 at each of the mesiobuccal aspects at the end of the straight leg parts 13 and the beginning of the curved part 11, there is a wing piece 20. Each of the wings 20 has the general shape part of a circle and they are designed to engage the inner upper lip of the user in the area of the nasolabial fold lines that run from the lower corner of each nostril to the corner of the lip. The wings 20 provide support to the upper lip.

The wings are made of a resilient material or have a resilient material in them in order to preload the wings so they automatically flex outward into contact with the tissue of the nasolabial fold so as to push it outwardly when the appliance is in place. If the appliance is shipped in a state in which the wings 20 are folded down onto the planar part 20 to reduce the size, the resilient nature of the wings will cause them to unfold into the proper position once unpacked.

An elongated lower bite pad 24 is located on the bottom surface of the planar part 12 in the area of each leg. This lower bite pad extends along most of the length and width of the lower surfaces of the leg parts 13, except for where the flaps 18 are located. Such a large bite pad will accommodate a large variety of users. The lower bite pads 24 are 1-2 mm, preferably about 2 mm, in height and are adapted to the occlusal (biting) surfaces of the lower teeth.

An elongated upper bite pad 26 is located on the top surface of the planar part or piece 12 along each leg pieces 13. The upper bite pads 26 also are preferably about 1-2 mm in height and are to adapt to the upper lingual cusps biting surfaces of the upper teeth primarily on the central groove and lingual cusp area, thereby not having the appliance occlude on the upper buccal cusps.

As shown in the cross sectional views of FIGS. 3B and 6, the planar part 12 may be made of a rigid core 30 surrounded by a moldable plastics material 32, which creates the upper and lower bite pads 26, 24. It should be noted that the upper bite pad extends completely across the top surface of planar piece 12 so as to accommodate a wide variety of sizes and arrangements of teeth. Similarly, except for the region of the flap 18, the bottom bite pad 24 extends across the entire region of the lower surface of the planar piece 12. The core 30 can be about 7 mm in height, the lower pad is 1-2 mm in height and the upper pad is 1-2 mm in height. Compared to the prior art, the flat 18 is lower and thinner (2 mm×2 mm) Being thinner allows for a larger surface for the lower bit pad to accommodate more users.

The posterior region of the bite pads 24 and 26 preferably have raised serrated markings 25 and 27 that extend across the widths of the pads. Similarly, the wings 20 have serrations 29. The bite pad serrations create friction between the teeth and the bite pads to stabilize the appliance during fitting. The serrations 29 on the wings also provide friction between the wings and the inner upper lip of the user in the area of the nasolabial fold lines to allow the wings to push out this part of the face to remove wrinkle lines. Without these serrations and/or other textured plastic, the inner lip may slide along the wings, thus producing less effective results.

These serration markings on the bite pads and wings can be 1 mm apart, or some other standard distance, and can be used as measurements to help users to accurately shorten the appliance legs or trim the wings to fit to their back teeth and upper lip, respectively. This can be done by cutting the appliance legs and wings with a knife (e.g., an Exacto knife), scissors or other similar tools.

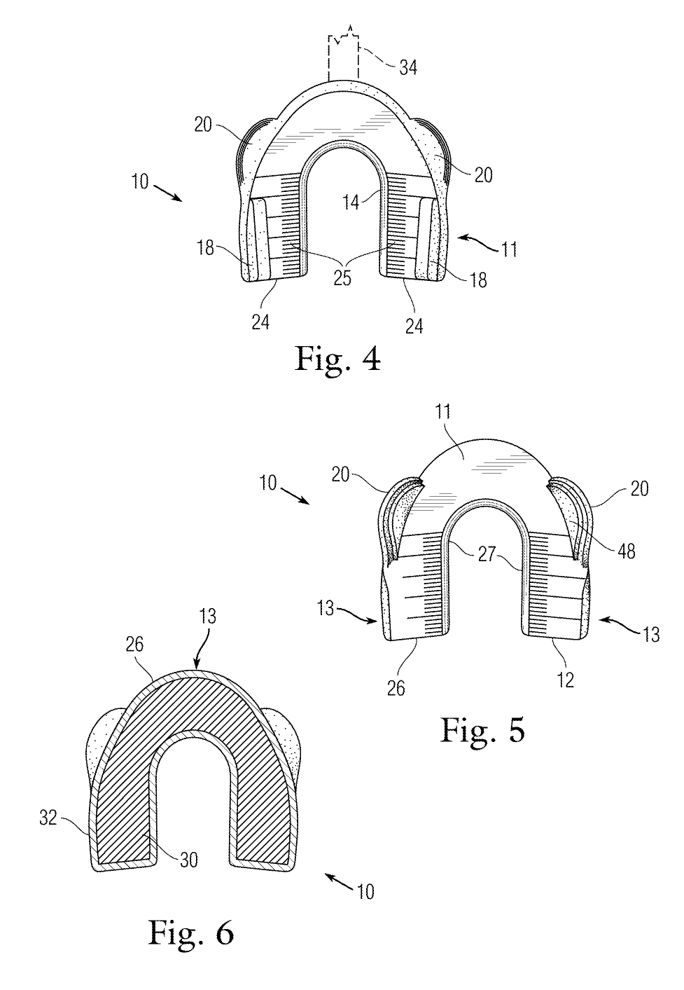

The appliance 10 is made of any suitable thermoplastic material such as ethylene vinyl acetate (EVA) that is currently used in dental carriers or trays and sports mouth guards. The appliance is to be fitted using a boil and bite technique in which the appliance is immersed in boiling water for a number of seconds, allowed to cool somewhat, and then placed in the mouth so the user can bite into the bite pads. While immersed in boiling water the user can hold onto the appliance by way of a handle 34 shown in dotted line in FIG. 4. This handle can be cut off when the bit pads are set or it can be retained and used as a guide to seat the appliance straight in the user's mouth.

Various parts of the appliance have different ductility so that they are more compliant to deformation and shaping when the fitting takes place. In general, the core of the planar piece 12 and the wings 20 have the least ductility (will be the hardest and least deformable after being immersed in the boiling water). The bite pads 24 and 26 have the greatest ductility and the flaps 18 having a ductility intermediate of the other two. The basic plastics material is modified with other plastics to create these differences in ductility.

Additives to the EVA provide special properties for the appliance, for example, a copolymer of ethylene. Examples of thermoplastic resins that can be used to form dental appliances according to the present invention include, but are not limited to, one or more of polyolefins, ethylene-vinyl acetate copolymer (EVA), ethylene-vinyl alcohol copolymer (EVAL), polycaprolactone (PCL), polyvinyl chloride (PVC), polyesters, polycarbonates, polyamides, polyurethanes, and polyesteramides. Examples of suitable polyolefins include, but are not limited to, polyethylene (PE), high density polyethylene (HDPE), low density polyethylene (LDPE), ultra-low density polyethylene (ULDPE), and polypropylene (PP). Thus, these materials with the necessary additives to obtain the desired ductility for its various parts can be used to make the appliance of the invention.

The appliance 10 can be made by any suitable conventional molding or heat forming technique. It can be made by a molding technique, such as injection molding, in which the planar part 12, wings 20, flaps 18 and bite pads 24 and 26 are fully integrated. To accomplish this, a multi-stage mold is used in which first the planar piece 12 and wings 20 are formed, then the flaps 18 and finally the bite pads 24 and 26. The appliance can also be fabricated by a vacuum-forming or pressure-forming process whereby the necessary laminar sheets of the appropriate EVA materials are heat adapted to a mold. The number and type of lamina used and the thickness at any point is determined by the shapes and sizes of the planar piece 12, wings 20, flaps 18 and the bite pads 24 and 26. For example, the appliance can be fabricated in a vacuum thermoforming device using layers of the materials in which the ductility is different.

Typical dimensions for the various parts of the appliance 10 are as follows:
a. width of the planar piece 12 from the outer edges of the legs 13 is about 58 mm,
b. overall length of appliance is about 48 mm,
c. thickness of planar piece 12 from the top of the upper bite pad to the bottom of the lower bite pad is 11-20 mm,
d. wings 20 are about 12-18 mm long (back to front), 7-10 mm high, and 5 mm thick,
e. bottom bite pads 24 are up to 20 mm wide, 30 mm long, 1-3 mm thick, and
f. top bite pads 26 are up to 25 mm wide, 30 mm long, 1-3 mm thick.

The appliance is to be fitted with the lower teeth on the lower bite pads 24 and the upper teeth on the upper bite pads 26. Because the appliance does not use channels in which the teeth are confined, but instead uses a planar part 12, it can accommodate a wide range of sizes and arrangements of teeth. Thus, with limited sizes of appliances, e.g., small, medium and large, nearly all users can be handled. The range of users can also be enhanced by trimming an appliance as appropriate. For example, using the serrations 25, 27, as a guild, the user can cut off a portion of the legs so they correspond to the back teeth of the user's jaws. In addition, a portion of the wings 20 can be trimmed so that they fit comfortably inside the upper lip of the user. Given the ability to trim the appliance, it may be preferable in some cases for the user to purchase an appliance that is larger than necessary and then to trim it to size.

Once any desirable trimming has taken place, the appliance 10 is dipped into boiling water which causes the parts, particularly the bite pads, to soften to different degrees as discussed above. After some cooling the appliance is then placed into the user's mouth. The flaps 18 will overlie the lower teeth and part of the lower gums and help to align the appliance. The wings 20 will engage the inside of the upper lip. The user then protrudes the lower jaw forward slightly from its normal position and bites into the upper and lower bite pads 24 and 26 to make impressions into which the upper and lower teeth will fit when the appliance is later used. As the user bites into the bite pads 24 and 26 to make the impressions the protrusion of the lower jaw should be about 1-3 mm, with 2 mm being preferred. Protrusion of the jaw should be practiced by the user prior to fitting. During the fitting the user should not protrude the jaw to an uncomfortable position.

After fitting, the appliance is allowed to completely cool and it will thereafter retain the shape configured during the fitting. In particular, the tooth impressions in the bite pads with the lower jaw protruded will remain. Then the appliance can be used repeatedly simply by the user placing it in her/his mouth so that the lower teeth fit into the depressions made in the lower bite pads 24 during the fitting and then moving the upper teeth into the depressions made in the upper bite pads 26. This will cause the protrusion established during the fitting process.

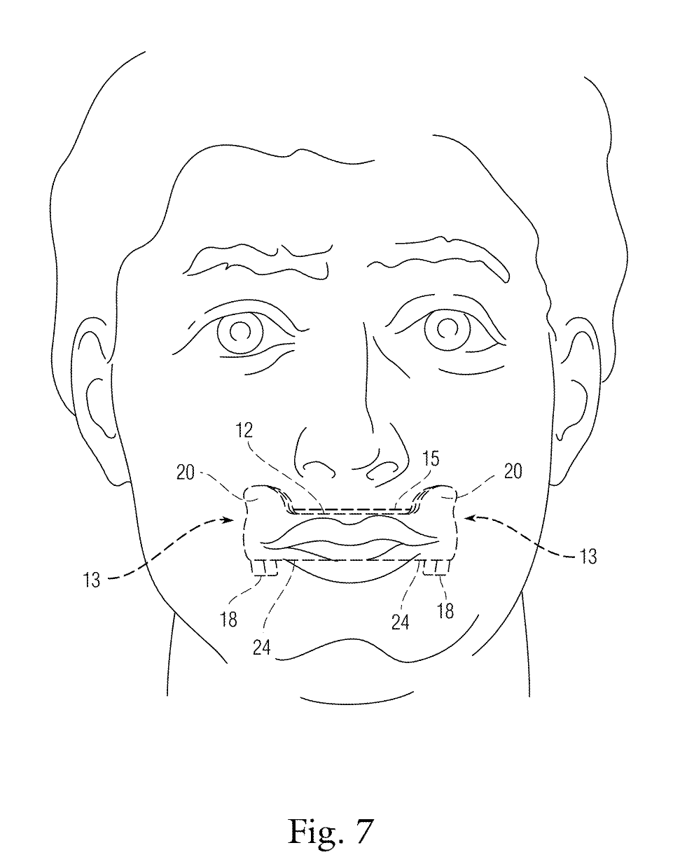

FIG. 7 shows the appliance 10 in place in the mouth. When a user is wearing the appliance both the bottom and top jaw teeth fit into the depressions in the bite pads to keep the jaw rest posture free space at about 7 mm. As noted above, the core of the planar piece 12 is typically about 7 mm thick and the surrounding soft material that forms the upper and lower bite pads each are 1-2 mm thick, respectively. The user's bite will usually extend substantially into the entire thicknesses of the bite pads leaving about, or somewhat more than 7 mm separation of the jaws. The 7 mm separation produces an increase of muscle tension that will strain the bones to give more support and create a more youthful appearance. A vertical re-establishment of 3 mm has been widely accepted by the dental community and is mentioned in dental textbooks. Maintaining the resting jaw position at 7 mm will cause an increase in muscle activity and, as a result, the muscles will see an increase in circulation, oxygen content, ATP production, glucose and calcium. The user is also able to separate the teeth from the appliance by opening the jaws more. This will increase the freeway space and further stretch the facial muscles.

Because the appliance when in place in the mouth will maintain the jaw protrusion used during the fitting, the protrusion will lightly tense the anterior belly of the digastric muscle. This will give support to the neck muscles and skin from below the chin point to the hyoid bone. This causes the muscles of the face and neck to give more facial support without being overworked.

As shown in FIG. 7, the wings 20 engage the cheek of the user in the area of the nasolabial fold lines running from the corner of the nostrils to the corners of the lips to support them and push them outwardly when the appliance is in place. The vertical surface 15 of the curved central part 11 of the U-shaped piece engages the lower lip around the mouth opening. This stretches the obicularis oris muscle so as to re-establish the sarcomere length.

It is suggested that when use is begun the appliance be worn for about two hours every other day for two months. Then, the user can reduce the time during which it is worn until it is about 5 minutes per day. The desired results are typically achieved during the first two months, and the continuing use helps to maintain the improvement.

While it is anticipated that the appliance will be worn during the day, it is also possible to put it in place while sleeping. However, it is preferable in such a night use that a thinner appliance be used to avoid constricting air flow during use. Further, in normal use the appliance should extend to the end of the second molar. However, it can be trimmed so that it only extends to the end of the first molar, which may make the fit more comfortable.

Specific features of the invention are shown in one or more of the drawings for convenience only, as each feature may be combined with other features in accordance with the invention. Alternative embodiments will be recognized by those skilled in the art and are intended to be included within the scope of the claims. Accordingly, the above description should be construed as illustrating and not limiting the scope of the invention. All such obvious changes and modifications are within the patented scope of the appended claims.

While the invention has been particularly shown and described with reference to preferred embodiments thereof, it will be understood by those skilled in the art that various changes in form and details may be made therein without departing from the spirit and scope of the invention.

What is claimed:

1. A dental appliance to fit between the upper and lower teeth of a user to reduce the effect of aging of the face, comprising:
a generally U-shaped planar piece of elastomeric material having a curved central part and two generally straight leg parts extending therefrom, said planar piece having an upper surface that is continuous and generally unobstructed;
bite pads of elastomeric material on the upper surface and a lower surface of each of the legs of the planar piece adapted to foam tooth impressions from a user's bite during fitting in which the user protrudes his lower jaw; and
wherein when tooth impressions on said bite pads on said upper and lower surfaces are engaged by the upper and lower teeth of a user during use, the appliance holds the jaws of the user protruded forward from a normal position by an amount of at least about 1 mm.

2. The dental appliance as claimed in claim 1 further comprising an elongated flap that extends along each leg of the planar piece from the bottom surface of said planar piece along the outer edge, said flaps engaging the outer sides of the lower teeth of the user so as to align the appliance during fitting and use.

3. The dental appliance as claimed in claim 1 further comprising a wing extending upwardly from each edge of the upper surface of the planar piece near the junction of the legs and the curved central part and being generally in the shape of part of a circle, said wings being adapted to engage and stimulate the inside of the upper lip of the user in the areas of the nasolabial fold lines.

4. The dental appliance as claimed in claim 4 wherein the wings are preloaded so as to flex outwardly into contact with the inside of the upper lip and support the nasolabial fold of the face during use.

5. The dental appliance as claimed in claim 1 wherein said planar piece is made of a core material surrounded by a moldable plastics material, said bite pads on said planar piece upper and lower surfaces being formed in the moldable plastics materials, and the moldable plastics material having greater ductility than the material of said planar piece core.

6. The dental appliance as claimed in claim 2 wherein said planar piece is made of a core material surrounded by a moldable plastics material, said bite pads on said planar piece upper and lower surfaces being formed in the moldable plastics materials, and said bite pads being made of a material that has greater ductility than the material of both said planar piece and said flaps.

7. The dental appliance as claimed in claim 6 wherein said flaps are of a material that is more ductile than that of said planar piece core and less ductile than that of said bite pads.

8. The dental appliance as claimed in claim 1 wherein, when the tooth impressions on said bite pads on said upper and lower surfaces are engaged by the upper and lower teeth, the appliance provides a vertical separation of at least about 7 mm between the opposing occlusal teeth surfaces.

9. The dental appliance as claimed in claim 2 wherein, when the tooth impressions on said bite pads on said upper and lower surfaces are engaged by the upper and lower teeth, the appliance provides a vertical separation of at least about 7 mm between the opposing occlusal teeth surfaces.

10. The dental appliance as claimed in claim 1 wherein, when the tooth impressions on said bite pads on said upper and lower surfaces are engaged by the upper and lower teeth, the appliance holds the jaws of a user protruded forward from a normal position by an amount in the range of from about 1-3 mm.

11. The dental appliance as claimed in claim 1 further including a low vertical wall located at the curved central part of the planar piece for contacting the lower part of the inside of the user's upper lip to help reduce aging lines in that area.

12. The dental appliance as claimed in claim 11 wherein the vertical wall has a textured surface to increase the friction contact between the wall and the inside of the lip.

13. The dental appliance as claimed in claim 1 further including spaced serrations on at least one of the bite pads to increase frictional contact between the user's teeth and the appliance to hold it in place.

14. The dental appliance as claimed in claim 13 wherein the serrations can be used as measurements and the leg parts can be severed from the appliance at selected serrations to shorten the legs to achieve a more comfortable fit.

15. The dental appliance as claimed in claim 3 further including spaced serrations on at least one of the wings to increase the friction contact between the wing and the inside of the inner upper lip in the area of the nasolabial fold lines.

16. The dental appliance as claimed in claim 15 wherein the serrations can be used as measurements and portions of the wings can be severed from the appliance at selected serrations to reduce the size of the wings to achieve a more comfortable fit.

17. A dental appliance to fit between the upper and lower teeth of a user to reduce the effect of aging of the face comprising:
a generally U-shaped planar piece of elastomeric material having a curved central part and two generally straight leg parts extending therefrom, said planar part having an upper surface that is continuous and generally unobstructed;
an elongated flap that extends along each leg of the planar piece from the bottom surface of said planar piece along the outer edge, said flaps engaging the outer sides of the lower teeth of the user so as to align the appliance during fitting and use;
bite pads of elastomeric material on the upper and lower surfaces of each of the legs of the channel piece into which the teeth of the user bite to make impressions during fitting, wherein the lower surface of the planar piece is continuous and unobstructed except for the elongated flaps, and the bite pads cover most of the upper and lower surfaces in the legs of the planar piece; and
a wing extending upwardly from each edge of upper surface of the planar piece near the junction of the legs and the curved central part, said wings being generally in the shape of part of a circle and being adapted to engage and stimulate the inside of the upper lip of the user in the areas of the nasolabial fold lines.

18. The dental appliance as claimed in claim 17 wherein the wings are preloaded so as to push outwardly against the inside of the upper lip.

19. The dental appliance as claimed in claim 17 wherein, when tooth impressions on said bite pads on said upper and lower surfaces are engaged by the upper and lower teeth of a user during use, the appliance provides a vertical separation of at least about 7 mm between the opposing occlusal teeth surfaces.

20. The dental appliance as claimed in claim 17 wherein, when tooth impressions on said bite pads on said upper and lower surfaces are engaged by the upper and lower teeth of a user during use, the appliance holds the jaws of the user protruded forward from a normal position by an amount in the range of from about 1-3 mm.

21. The dental appliance as claimed in claim 17 further including a low vertical wall located at the curved central part of the planar piece for contacting the lower part of the inside of the user's upper lip to help reduce aging lines in that area, said low vertical wall has a textured surface to increase the friction contact between the wall and the inside of the lip.

22. The dental appliance as claimed in claim 17 further comprising:
spaced serrations on at least one of the bite pads to increase frictional contact between the user's teeth and the appliance to hold it in place,
spaced serrations on at least one of the wings to increase the friction contact between the wing and the inside of the inner upper lip in the area of the nasolabial fold lines, and
wherein the serrations can be used as measurements so leg and wing parts can be severed from the appliance at selected serrations to achieve a more comfortable fit.

23. The dental appliance as claimed in claim 17 further including a handle attached to the front edge of the curved central part to support the appliance during a boil and bit fitting process and to guide the appliance straight into the user's mouth.
